(19) United States
(12) Patent Application Publication
(10) Pub. No.: US 2020/0194910 A1
(43) Pub. Date: Jun. 18, 2020

(54) CONNECTION DEVICE FOR CONNECTING AT LEAST ONE ELECTRICAL CONDUCTOR TO A STUD TERMINAL

(71) Applicant: PHOENIX CONTACT GMBH & CO. KG, Blomberg (DE)

(72) Inventors: Gordon BUSCH, Blomberg (DE); Heinz REIBKE, Bad Salzuflen (DE); Kevin BERGHAHN, Blomberg (DE); Moritz KRINK, Detmold (DE)

(21) Appl. No.: 16/609,454

(22) PCT Filed: May 7, 2018
(86) PCT No.: PCT/EP2018/061675

§ 371 Date: Oct. 30, 2019

(30) Foreign Application Priority Data
May 16, 2017 (DE) 10 2017 110 645.6

(51) Int. Cl. H01R 11/11; H01R 4/34; H01R 4/48

(52) U.S. Cl. CPC H01R 11/11; H01R 4/4818; H01R 4/34

(57) ABSTRACT

A connection device for connecting at least one electrical conductor to a stud terminal includes: a contact element which has a connecting section for attaching to a stud of the stud terminal; and a housing that has at least one plug opening configured for inserting an electrical conductor. The electrical conductor is in electrical contact with a contact section of the contact element when the electrical conductor is inserted into the at least one plug opening.

### CROSS-REFERENCE TO PRIOR APPLICATIONS

This application is a U.S. National Phase application under 35 U.S.C. § 371 of International Application No. PCT/EP2018/061675, filed on May 7, 2018, and claims benefit to German Patent Application No. DE 10 2017 110 645.6, filed on May 16, 2017. The International Application was published in German on Nov. 22, 2018 as WO/2018/210599 under PCT Article 21(2).

### FIELD

The invention relates to a connection device for connecting at least one electrical conductor to a stud terminal.

### BACKGROUND

Such a connection device comprises a contact element which has a connecting section for attachment to a stud of the stud terminal.

DE 31 02 640 B2 discloses, for example, a clamping plate for connecting electrical conductors to an electrical device. In this case, a holder has connection terminals and can be connected to a metal part of an electrical device via a contact strip with an eyelet.

Stud terminals often serve to electrically contact electrical cables having a large conductor cross-section. For this purpose, such cables have cable lugs which can be placed on a stud of a stud terminal in order to establish an electrical contact in this way. If further electrical conductors, for example with smaller conductor cross-sections, are to be connected to such contact points, it may be necessary to clamp the conductors between a cable lug of an electrical cable (with a large conductor cross-section) and the stud terminals, which may be laborious and, moreover, possibly provides only an unreliable electrical contact.

DE 10 2006 057 712 B3 discloses a spring-force clamp into which a cable lug can be inserted.

A connection device for electrical cables with cable lugs is also known from DE 20 2004 002 779 U1.

### SUMMARY

In an embodiment, the present invention provides a connection device for connecting at least one electrical conductor to a stud terminal, comprising: a contact element which has a connecting section configured to attach to a stud of the stud terminal; and a housing that has at least one plug opening configured for inserting an electrical conductor, wherein the electrical conductor is in electrical contact with a contact section of the contact element when the electrical conductor is inserted into the at least one plug opening.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1A a side view of an exemplary embodiment of a connection device;

FIG. 1B a perspective view of the connection device;

FIG. 2A a side view of another exemplary embodiment of a connection device;

FIG. 2B a perspective view of the connection device;

FIG. 3 a view of the connection device according to FIG. 1A, 1B on a stud terminal;

FIG. 4 the arrangement according to FIG. 3, in addition having electrical cables arranged on a stud of the stud terminal via cable lugs;

FIG. 5 a view of an arrangement having two connection devices arranged on a stud terminal;

FIG. 6A a side view of the arrangement according to FIG. 5;

FIG. 6B a sectional view along line A-A according to FIG. 6A; and

FIG. 7 a schematic view of a spring-force connection of the connection device for connecting an electrical conductor.

### DETAILED DESCRIPTION

In an embodiment, the present invention provides a connection device for connecting at least one electrical conductor to a stud terminal, which makes it possible, in a easy-to-handle way, to establish a reliable electrical contact between electrical conductors, which may have a small conductor cross-section, and a stud terminal.

Accordingly, the connection device has a housing which has at least one plug opening for inserting an electrical conductor, wherein the electrical conductor is in electrical contact with a contact section of the contact element when the electrical conductor is inserted into the at least one plug opening.

The connection device thus has one or more plug openings, into which one or more electrical conductors (for example having a small conductor cross-section) can be inserted. When the conductors have been inserted into the plug openings, they contact a contact section of the contact element and are connected in this manner to the stud terminal when the contact element is attached to a stud of a stud terminal. By arranging an electrical cable, for example with a cable lug, on the stud terminal, it is thus possible to contact electrical conductors (for example with a small conductor cross-section) with one or more electrical cables (possibly with a large conductor cross-section).

One or more plug openings are formed in the housing of the connection device. A conductor can be plugged into one of the plug openings in a plug-in direction and in this way contacts the contact section of the contact element.

The connecting section of the contact element can, for example, have an opening in the nature of an eyelet, by means of which the connecting section can be placed onto the stud of the stud terminal. The stud can be designed, for example, as a threaded stud so that, by using a fastening element in the nature of a screw nut, the connecting section can be fixed to the stud and clamped, for example, with a cable lug of an electrical cable.

In one embodiment, the connecting section is formed as a tab protruding from the housing. The connecting section thus projects out of the housing and protrudes from the housing so that the connection device can be connected to a stud terminal via the connecting section of the contact element.

In one embodiment, the connection device implements a spring-force connection for connecting one or more electrical conductors. For this purpose, the at least one plug opening can be associated with a spring element which serves to lock an electrical conductor inserted into the plug opening in the plug opening in a clamping manner and thus firstly to hold it mechanically on the connection device and secondly to connect it electrically to the contact section of the contact element.

Such a spring element can have a clamping leg and a retaining leg, for example. Via the retaining leg the spring element is supported relative to the housing and is thus held in the housing. In contrast, the clamping leg, which may be angled relative to the retaining leg, extends freely and shiftably in the housing and serves to press the conductor against the contact section of the contact element in the inserted position.

The clamping leg is preferably elastically shiftable relative to the retaining leg. In particular, the spring element can enable so-called direct insertion, in which an electrical conductor is inserted into a plug opening and thereby interacts with the clamping leg of the spring element associated with the plug opening in such a way that the clamping leg is deflected. As a result, the spring element is elastically tensioned so that the spring element exerts a spring force on the electrical conductor via the clamping leg, in order thus to mechanically lock the electrical conductor in the plug opening and additionally to press it into electrical contact with the contact section of the contact element.

In one embodiment, the connection device has an actuating element which is shiftably arranged on the housing. The actuating element serves in particular to release a conductor inserted into a plug opening from the plug opening. For this purpose, the actuating element can lie, for example, with a body in an opening of the housing and is thus guided displaceably in the opening. An actuating section protrudes from the body and acts on the clamping leg when the actuating element is shifted and thus shifts it in relation to the retaining leg in such a way that a clamping force on the electrical conductor is released.

The actuating element can be actuatable, for example, manually or by using a tool, for example a screwdriver or the like.

In one embodiment, the contact section can be inclined in relation to the connecting section. The contact section and the connecting section of the contact element thus extend at an oblique angle to each other, wherein the contact section is preferably at least partially enclosed by the housing and serves to electrically contact an electrical conductor inserted into a plug opening of the housing. Because the contact section extends obliquely to the connecting section, a plug-in direction in which a conductor is to be inserted into a plug opening of the housing can be oriented obliquely in such a way that a simple plugging of electrical conductors into the connection device is possible even when the connection device is arranged on a stud terminal.

An arrangement preferably comprises a connection device of the type described above and a stud terminal having a stud. An electrical cable can be attached to the stud of the stud terminal by means of a cable lug and connected to the stud terminal in this manner so that electrical conductors (for example having a small conductor cross-section) connected to the connection device can be electrically contacted with the electrical cable (possibly with a large conductor cross-section).

The stud can take the form of a threaded stud onto which a fastening element, for example in the form of a screw nut, can be screwed so that the connection device and possibly one or more electrical cables can be fixed to the stud terminal in this way.

In principle, one or more connection devices and also one or more electrical cables with cable lugs can be connected to such a stud terminal. For this purpose, the cable lugs of the electrical cables and the connecting sections of the contact elements of the connection devices are stacked on the stud one above the other and clamped to each other via a fastening element so that the electrical cables and the connection devices are mechanically held on the stud and also electrically contacted with one another.

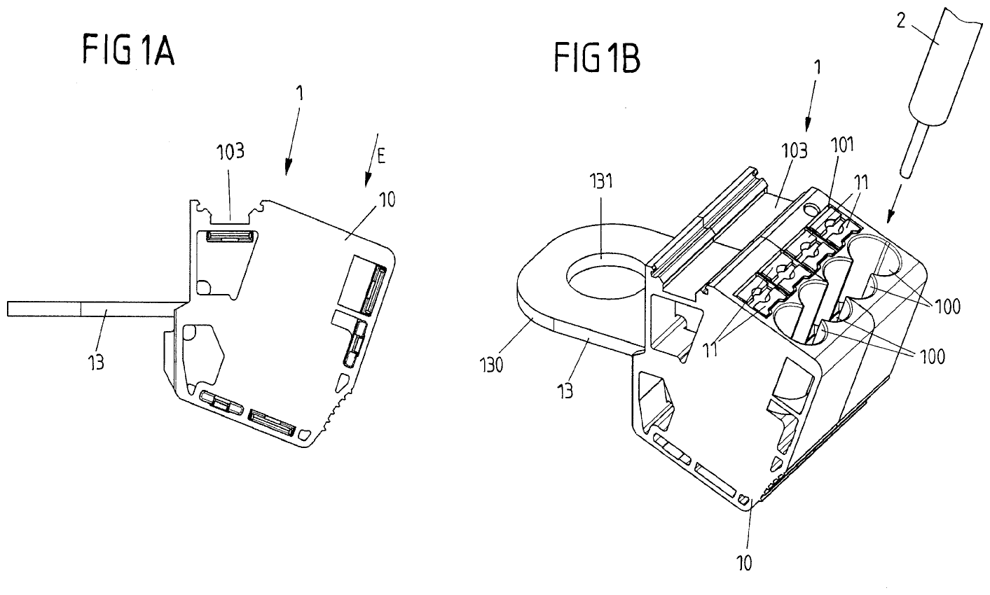

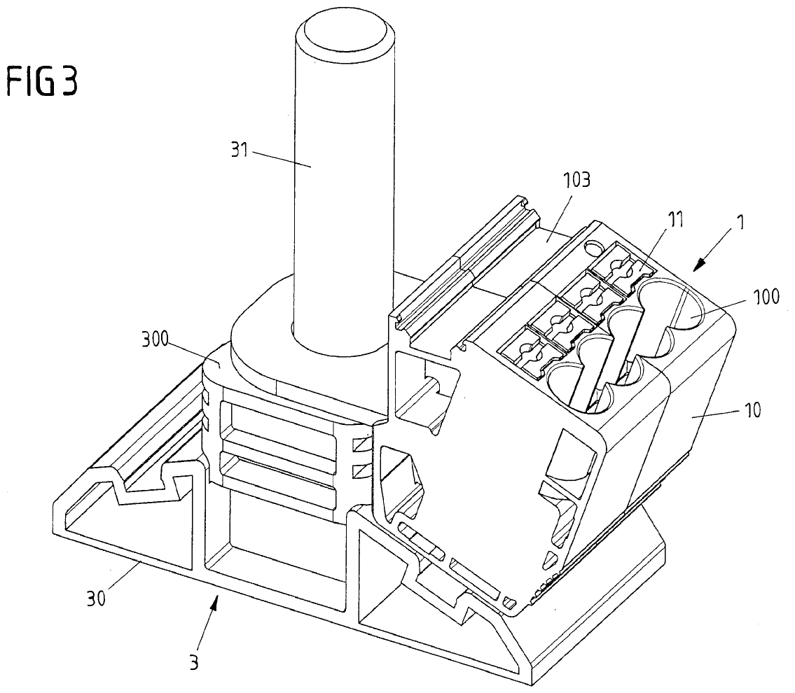

FIGS. 1A and 1B show an exemplary embodiment of a connection device 1 which serves to connect electrical conductors 2, which may optionally have a small conductor cross-section, to a stud terminal 3 (see FIG. 3).

For this purpose, the connection device 1 has a housing 10 with plug openings 100 formed therein, into which electrical conductors 2 can be inserted along a plug-in direction E in order to electrically contact a contact element 13 within the housing 10. The contact element 13 protrudes from the housing 10 in the manner of a tab and has a connecting section 130 with an opening 131 shaped therein in the manner of an eyelet, by means of which the connection device 1 can be attached to a stud 31 of a stud terminal 3, as shown in FIG. 3.

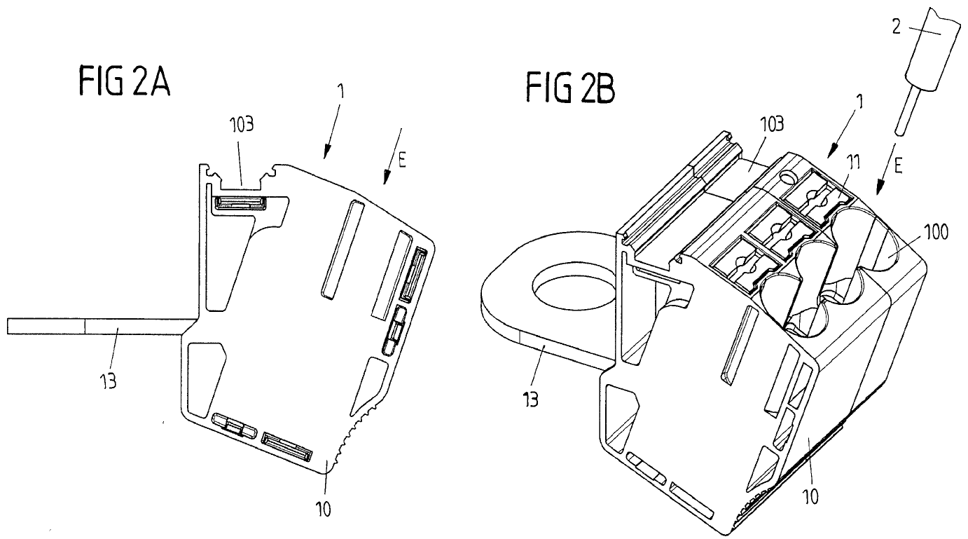

While in the exemplary embodiment according to FIGS. 1A, 1B four plug openings 100 arranged in a row transversely to the plug-in direction E are provided on the housing 10, a connection device 1 shown in FIGS. 2A, 2B has three plug openings 100 arranged in a row transversely to the plug-in direction E. The plug openings 100 of the exemplary embodiment according to FIGS. 2A, 2B may, for example, have a diameter which is larger than the plug openings 100 of the exemplary embodiment in accordance with FIGS. 1A, 1B so that the connection device 1 according to FIGS. 2A, 2B is suitable for connecting electrical conductors 2 with a (somewhat) larger conductor cross-section.

In each case, a plate support section 103 is formed on the housing 10 to which identification plates for identifying, for example, electrical conductors 2 inserted into the plug openings 100 can be affixed.

The connection device 1 realizes, both in the exemplary embodiment according to FIGS. 1A, 1B and in the exemplary embodiment according to FIGS. 2A, 2B, spring force connections by means of which the electrical conductors 2 can be locked and contacted with spring force to the connection device 1.

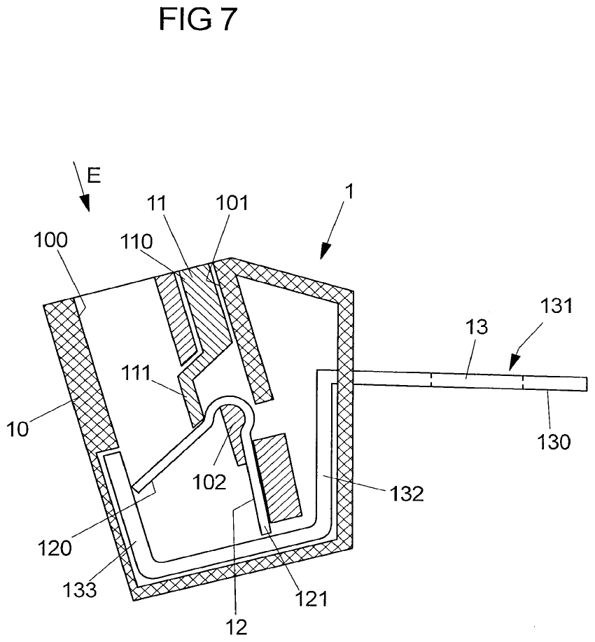

As schematically shown in FIG. 7, each plug opening 100 is associated with a spring element 12 which is elastically resilient, for example made of spring steel, and has a clamping leg 120 and a retaining leg 121 supported on the housing 10. As can be seen from FIG. 7, the clamping leg 120 projects into the region of the associated plug opening 100 and serves to clamp an electrical conductor inserted into the plug opening 100 to the connection device 1 so that the electrical conductor 2 is mechanically locked in the plug opening 100 and is also electrically contacted with a contact section 133 of the contact element 13 extending in the housing 10.

The connection device 1 in particular enables direct insertion of electrical conductors 2. When an electrical conductor 2 is inserted into a plug opening 100, the electrical conductor 2 with a stripped conductor end comes into contact with the clamping leg 120 and deflects the latter relative to the retaining leg 121. The conductor end of the electrical conductor 2 hereby gets into an intermediate position between the clamping leg 120 and the contact section 133 of the contact element 13 so that the electrical conductor 2 is clamped to the contact section 133 and in this manner also electrically contacts the contact section 133.

As can be seen from FIGS. 1B and 2B, each plug opening 100 is associated with an actuating element 11 which has a body 110 and an actuating section 111 protruding from the body 110 (see FIG. 7). With the body 110, the actuating element 11 lies in an associated opening 101 of the housing 10 and is guided in a displaceable manner on the housing 10.

The actuating element 11 serves to release an electrical conductor 2 inserted into the associated plug opening 100 from the plug opening 100. For this purpose, a user can act on the body 110 of the actuating element 11, for example with a tool, for example a screwdriver, and press it into the housing 10 so that the actuating section 111 thereby interacts with the clamping leg 120 and moves the latter out of its clamping abutment with the electrical conductor 2. The mechanical locking of the electrical conductor 2 in the plug opening 100 is thus released so that the electrical conductor 2 can be removed from the housing 10 counter to the plug-in direction E.

The spring element 12 takes the form of a bent leg spring and extends around a housing section 102 of the housing 10. The spring element 12 is supported relative to the housing 10 via the retaining leg 121 so that when the clamping leg 120 is deflected, the retaining leg 121 is not moved with it.

As can be seen from FIGS. 1A, 1B, 2A, 2B and FIG. 7, the plug-in direction E extends obliquely to the connecting section 130 of the contact element 13. In addition, the contact section 133 of the contact element 13 is also oriented obliquely to the connecting section 130. This makes it possible to attach electrical conductors 2 to the connection device 1 in a simple, convenient manner, even if the connection device 1 is arranged on a stud terminal 3, as shown in FIG. 3.

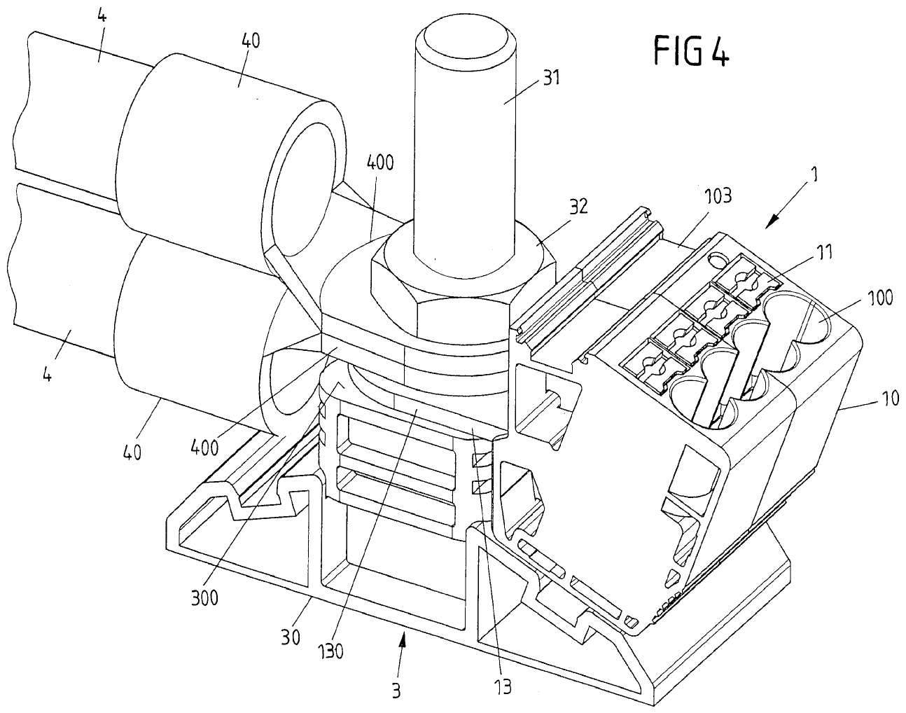

As shown in FIG. 3, the stud terminal 3 has a foot 30 which is made, for example, of an electrically insulating material, for example a plastic material. A stud 31 is arranged on the foot 30 and is made of an electrically conductive material, in particular a metal material, and is configured, for example, as a threaded stud so that a fastening element 32 in the manner of a screw nut, as shown in FIG. 4, can be screwed onto the stud 31 in order to fasten a connection device 1 attached to the stud terminal 3 to the stud terminal 3.

One or more connection devices 1 and also one or more electrical cables 4 can be connected to such a stud terminal 3.

For example, FIG. 4 shows an arrangement in which a connection device 1 and in addition two electrical cables 4 with cable lugs 40 are attached to the studs 31 of the stud terminal 3. The connecting section 130 of the contact element 13 of the connection device 1 rests here on a support section 300 of the foot 30 of the stud terminal 3, while the cable lugs 40 with connecting sections 400 are stacked above it. The cable lugs 40 and the contact element 13 are clamped to each other via a fastening element 32, electrically contact each other and are also mechanically fastened to the stud terminal 3.

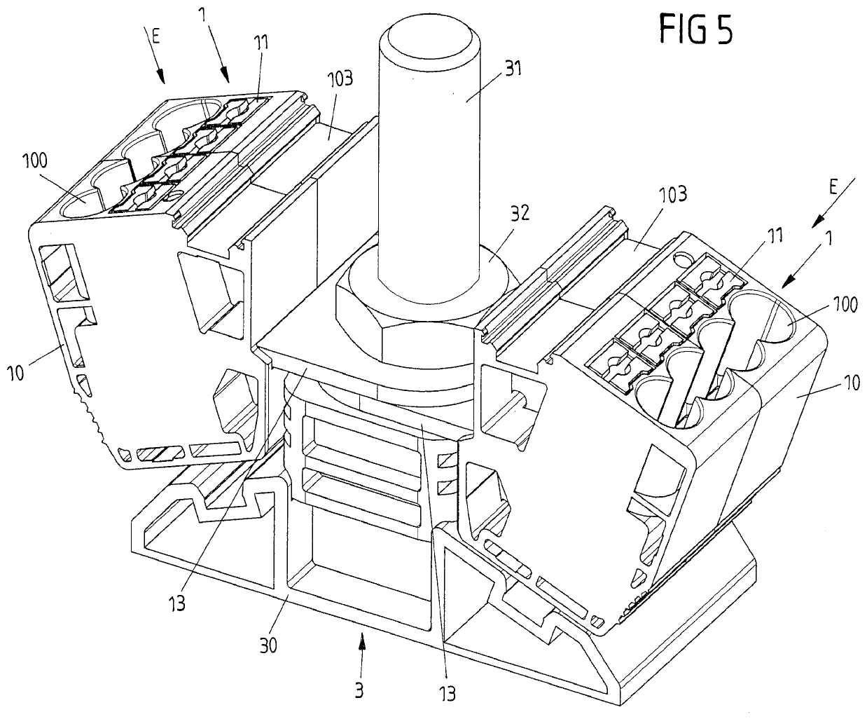

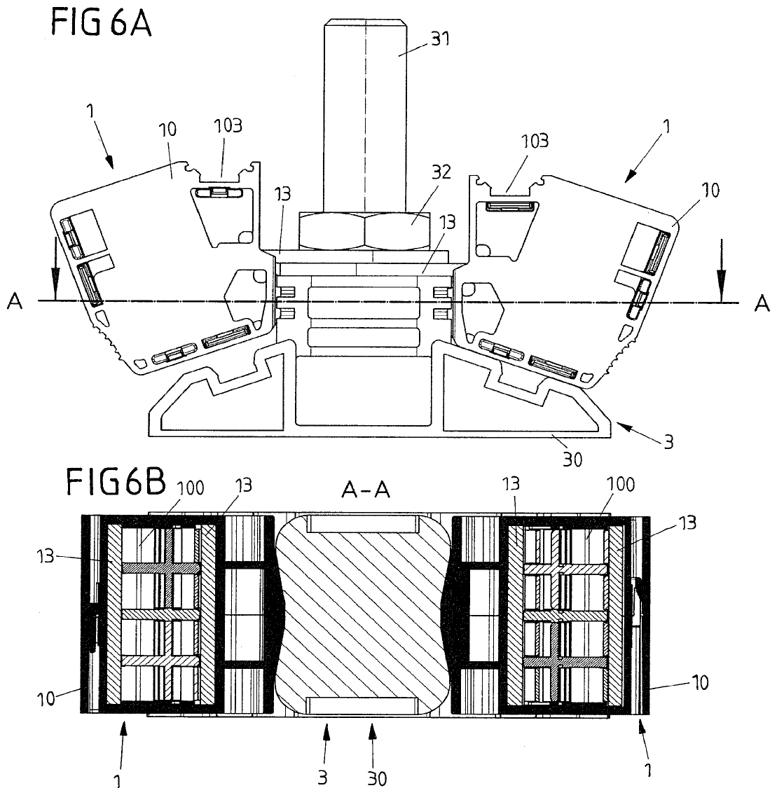

FIG. 5 shows, in contrast, an arrangement in which two connection devices 1 are arranged on a stud terminal 3. FIG. 6A shows the arrangement according to FIG. 5 in a side view, and FIG. 6B shows a sectional view along line A-A according to FIG. 6A.

Conductors 2 having a comparatively small conductor cross-section can be connected to electrical cables 4 having a comparatively large conductor cross-section on a stud terminal 3 via a connection device 1 of the type described. In this case, a connection device 1 can have plug openings 100 of different diameters for connecting conductors 2 with different conductor cross-sections. For example, a plurality of rows of plug openings 100 for connecting conductors 2 with the same or different conductor cross-sections can also be provided on one connection device 1.

Basically any number of connection devices 1 of the same or different design and in addition any number of electrical cables 4 with cable lugs 40 can be connected to one stud terminal 3. The number of connectable connection devices 1 and electrical cables 4 is limited solely by the available installation space and the length of the stud 31 of the stud terminal 3.

The idea underlying the invention is not limited to the exemplary embodiments described above but can in principle be realized in a completely different manner.

The connection device enables electrical conductors to be inserted in a plug-in manner. In this case, the connection device can have spring-force connections, wherein in principle it is also conceivable to provide connections of different types (without the use of spring elements) on the connection device.

A stud terminal can have one or more studs to which connection devices and electrical cables with cable lugs can be attached. Connection devices and electrical cables can thus be electrically contacted with one another via such a stud terminal.

Such a stud terminal can be attached to a support rail, for example, so that the stud terminal can be combined, for example, with other clamping devices, for example series clamps or the like.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Connection device
10 Housing
100 Plug opening
101 Opening
102 Housing section
103 Plate support section
11 Actuating element
110 Body
111 Actuating section
12 Spring element
120 Clamping leg
121 Retaining leg
13 Contact element (bus bar)
130 Connecting section
131 Opening
132 Section
133 Contact section
2 Conductor
3 Stud terminal
30 Foot
300 Support section
31 (Threaded) stud
32 Fastening element (nut)
4 Cable
40 Cable lug
400 Connecting section
E Plug-in direction

1: A connection device for connecting at least one electrical conductor to a stud terminal, comprising:
a contact element which has a connecting section configured to attach to a stud of the stud terminal; and
a housing that has at least one plug opening configured for inserting an electrical conductor,
wherein the electrical conductor is in electrical contact with a contact section of the contact element when the electrical conductor is inserted into the at least one plug opening.

2: The connection device according to claim 1, wherein the connecting section has an opening into which the stud is insertable.

3: The connection device according to claim 1, wherein the connecting section comprises a tab protruding from the housing.

4: The connection device according to claim 1, wherein the at least one plug opening is associated with a spring element configured to lock the electrical conductor in the inserted position in a clamping manner.

5: The connection device according to claim 4, wherein the spring element comprises a clamping leg and a retaining leg,
wherein the spring element is supported via the retaining leg relative to the housing and the clamping leg is configured to press the conductor against the contact section of the contact element in the inserted position.

6: The connection device according to claim 5, wherein the clamping leg is elastically shiftable relative to the retaining leg.

7: The connection device according to claim 5, further comprising an actuating element which is shiftably arranged on the housing and is actuatable in order to release the conductor from the inserted position by acting on the clamping leg of the spring element.

8: The connection device according to claim 7, wherein the actuating element is guided displaceably in an opening of the housing and has an actuating section configured to shift the clamping leg relative to the retaining leg.

9: The connection device according to claim 1, wherein the contact section extends obliquely to the connecting section.

10: An arrangement, comprising:
the connection device according to claim 1; and
a stud terminal having a stud.

11: The arrangement according to claim 10, further comprising an electrical cable having a cable lug with a connecting section configured to connect to the stud.

12: The arrangement according to claim 10, wherein the stud comprises a threaded stud onto which a fastening element for fastening the connection device to the stud is screwable.
